(19) United States
(12) Patent Application Publication
(10) Pub. No.: US 2023/0166132 A1
(43) Pub. Date: Jun. 1, 2023

(54) MOUTH MASK

(71) Applicant: VINYA-PLASTICS, naamloze vennootschap, Borsbeek (BE)

(72) Inventor: Aristide Melissas, Antwerp (BE)

(73) Assignee: VINYA-PLASTICS, naamloze vennootschap, Borsbeek (BE)

(21) Appl. No.: 17/922,102

(22) PCT Filed: Apr. 30, 2021
(86) PCT No.: PCT/IB2021/053623

§ 371 Date: Oct. 28, 2022

(30) Foreign Application Priority Data
Apr. 30, 2020 (BE) 20205286

(51) Int. Cl. A62B 18/02; A62B 23/02

(52) U.S. Cl. CPC A62B 18/02; A62B 23/025

(57) ABSTRACT

A mouth includes four pieces of plastic foil or layers placed against each other, in particular a first external layer, a first internal layer, a second internal layer and a second external layer, these layers having at least partially corresponding peripheral edges, and wherein the four pieces of plastic foil or layers are connected along a first fraction of their corresponding peripheral edges by a quadruple welded joint connecting the four layers.

### CROSS-REFERENCE TO RELATED APPLICATIONS

The present application is the National Phase entry of International Patent Application No. PCT/IB2021/053623 filed Apr. 30, 2021, which claims priority to Belgium Patent Application No. 2020/5286 filed Apr. 30, 2020, the entire contents of which are hereby incorporated by reference into this application.

### TECHNICAL FIELD

The present disclosure relates to a mouth mask.

More specifically, the present disclosure relates to a reusable mouth mask that can be fitted with replaceable filters.

### BACKGROUND

There are many types of reusable mouth masks, but all are characterised by associated disadvantages.

Some reusable mouth masks are made of woven fabric and have an interior space for inserting an easily replaceable filter. These reusable mouth masks should be washed daily for disinfection. Moreover, such mouth masks are not easy to manufacture in very large quantities in an economic manner.

Other reusable mouth masks are made of plastic but have complex or expensive replaceable filters.

The present disclosure therefore aims to provide a solution to the aforementioned and/or other problems.

### SUMMARY

The main object of the present disclosure is to economically produce reusable mouth masks in very large quantities and at very high production rates.

In the context of a pandemic or widespread epidemic, it is crucial to be able to manufacture such mouth masks at very high production rates.

Mass distribution is a challenge of the present disclosure.

Getting masks to large populations en masse and quickly is a crucial step in fighting or containing a viral outbreak.

To this end, the present disclosure relates to a mouth mask comprising substantially four pieces of plastic foil or layers placed on top of or against each other, more particularly a first external layer, a first internal layer, a second internal layer and a second external layer, which layers have at least partially corresponding peripheral edges, and wherein the four pieces of plastic foil or layers are connected to each other along a first fraction of their corresponding peripheral edges by a quadruple welded joint connecting the four layers, and wherein the first external layer and the first internal layer, on the one hand, and the second internal layer and the second external layer, on the other hand, are joined along a second fraction of their corresponding peripheral edges by a first and second double welded joint respectively, and wherein the internal layers are not connected along this second fraction of their corresponding peripheral edges, and wherein no weld is provided along a third fraction of the peripheral edge and the four pieces of plastic foil or layers are unbound there.

Put differently, the mask is composed of four pieces of plastic foil or layers placed on top of or against each other with substantially corresponding peripheral edges, and the four layers are all connected over a portion of the at least partly common peripheral edge by a quadruple welded joint, while the two first adjacent layers, on the one hand, and the two second adjacent layers, on the other hand, are joined over another portion of the peripheral edge by a double welded joint, and wherein yet another part of the peripheral edge is not welded, so that the four pieces there are not bound.

By quadruple welded joint is meant in this case that four layers are or have been connected by such a welded joint.

By double welded joint is meant in this case that two layers are or have been connected by such a welded joint.

The mouth mask according to the present disclosure has a 2D or two-dimensional shape in the absence of external forces.

Also, the mouth mask is composed of flat or two-dimensional layers of plastic foil which can be manufactured in a very efficient manner, placed on top of each other and, as explained, can be connected by appropriate welded joints.

The flat 2D shape allows very compact stacking and thus simplifies all logistics operations. No damage occurs due to massive, compact stacking.

The two-dimensional shape is transformed into a three-dimensional shape by opening the layers of the mouth mask in the middle.

This is achieved, for example, by increasing the space between the first external layer and the second external layer. The internal layers follow this movement due to the special joints.

According to some embodiments, the four pieces of plastic foil or layers exhibit a convex shape at the first fraction of their respective peripheral edges, where the quadruple welded joint connects the four layers to each other.

In some embodiments, the first fraction of the peripheral edges exhibits a curved line.

This results in the four layers being joined there, which, when the layers are opened up beyond the connection line between the far ends of the first fraction of the peripheral edges, induces a deformation with, more specifically, the far ends of the first fraction of the peripheral edges being moved towards each other.

Thus is obtained an appropriate cup shape to be placed on the nose and mouth.

### BRIEF DESCRIPTION OF THE DRAWINGS

In order to better explain the characteristics of the present disclosure, the following embodiment of a mouth mask according to the present disclosure is described below by way of example only, without being limitative in any way, with reference to the accompanying Figures, in which:

FIG. 1 shows a front view of a mouth mask according to the present disclosure put into use;

FIG. 2 shows a side view of the mouth mask according to FIG. 1;

FIG. 3 shows the same mouth mask according to the present disclosure in its folded state; and

FIG. 4 shows the same mouth mask according to the present disclosure in the process of being fitted with a replaceable filter.

### DETAILED DESCRIPTION

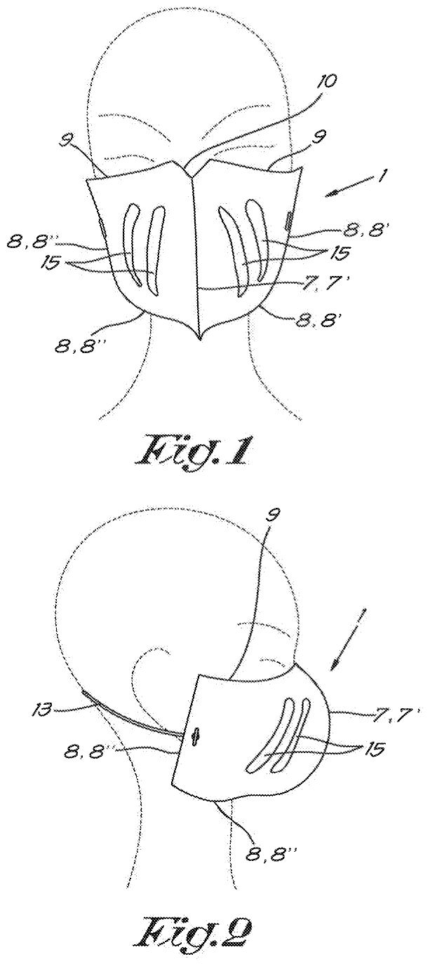

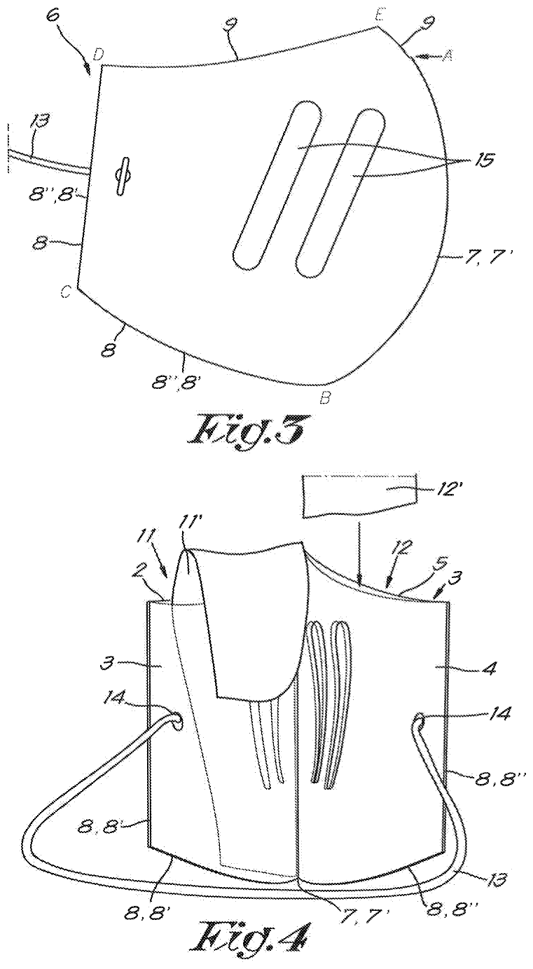

The mouth mask 1 according to the present disclosure is shown in FIGS. 1 and 2 in its position of use, and in FIG. 3 in its flat, folded state.

In its position of use, the mask 1 covers the nose to almost between the eyes, the mouth and extends to underneath the chin. On the left and right, the corners of the mouth and the cheeks are covered up to the ears. Of course, this depends on how well the mask 1 fits the user's anatomy.

For simplicity's sake, when referring to parts of the mask 1, the underlying facial zone is often mentioned.

For example, when referring to the chin of the mask, it is clear that this refers to the part of the mask that is intended to cover the chin.

FIG. 3 shows the folded position, which is the position that the mask normally assumes when no external forces are applied on the latter.

FIG. 4 illustrates how the mouth mask 1 is made up of four pieces of plastic foil or layers. From the rear left in FIG. 4, across the front to the rear right: a first external layer 2, first internal layer 3, second internal layer 4 and second external layer 5.

This view according to FIG. 4 is seen from the point of view of the user looking at the space between the internal layers 3 and 4, more specifically by slightly opening the internal layers 3 and 4.

The mouth mask 1 is substantially composed of four pieces of plastic foil 2, 3, 4 and 5, placed on top of or against each other, with peripheral edges 6 corresponding entirely in this case—but which is not absolutely necessary, and wherein the four pieces 2 to 5 are connected along a first fraction 7 of the peripheral edge 6, shown in the Figures from point A to point B, by a first quadruple welded joint 7′ which connects the four layers 2 to 5.

This first fraction 7 of the peripheral edge 6, also called the nose-chin line, is placed on the nose and underneath the chin when in use, with A at the nasal bone and B on the chin.

The nose-chin line has a curved shape which corresponds mainly to the segment of a circle having a radius between 7 and 14 centimetres.

In the position of use, the nose occupies the space beyond the line joining the ends A and B and thereby also opens up these layers 3 and 4 beyond the line joining the ends A and B, bringing these ends A and B together as a result, and the appropriate cup shape is further obtained.

Along a second fraction 8 of the peripheral edge 6, shown in the Figures from points B to D, a first double welded joint 8′ is provided. It only connects two adjacent pieces of plastic foil 2 and 3, i.e. the first external layer 2 and first internal layer 3.

The second fraction 8 of the peripheral edge 6 extends from point B, the chin of the mask 1, over point C, corresponding to the angle in the mandible towards the maxillary joint, and to point D, corresponding to the maxillary joint.

In a completely similar manner, along the same second fraction 8 of the peripheral edge 6, shown in the Figures from points B to D, a second double welded joint 8″ is provided. It only connects the two adjacent pieces of plastic foil 4 and 5.

No weld is provided along a third fraction 9 of the peripheral edge 6, shown in the Figures from points D to A. In other words, the four pieces of plastic foil 2 to 5 are not joined there.

At the top and between points A and D, the peripheral edge 6 shows a specific kink which, when the mask 1 is unfolded, represents a V-shaped incision 10 between two pointed shapes directed towards the medial corners of the eye for an optimal fit of the mask 1 onto the nasal bone and towards the deeper lying eyes.

The welded joints and the overall layered construction as discussed provide two so-called “pockets” or tight-fitting pockets 11 and 12 into which filter material 11′ and 12′ can be inserted, for example cut-to-size kitchen roll paper, coffee filter paper or similar.

The pieces of plastic foil 2 and 5, which are visible when in use, are made in this case—but not necessarily—of opaque, coloured vinyl.

The pieces of plastic foil 3 and 4 facing the face when in use are made in this case—but not necessarily—of anti-allergenic, biocompatible vinyl, in this particular case of a matt transparent variant.

An elastic band or ribbon 13 of suitable or adjustable length is connected in an appropriate manner to the thus obtained mouth mask 1. To this end, the four layers 2 to 5 are provided with a corresponding passage 14.

Layers 2 to 5 are also provided with passages 15 which serve as breathing holes.

The passages 15 are similar here, but not necessarily in all layers 2 to 5.

It is clear that the welded joints must not be continuous.

It is also clear that the shape must not exhibit all the features shown in the figures, although this particular shape does provide an ideal fit on the face.

The contour shapes of the layers 2 to 5 do not necessarily have to correspond, especially where no welded joint is provided. The internal layers 3 and 4 could, for example, be made slightly smaller.

The use of the mouth mask 1 according to the present disclosure is simple and as follows.

In some embodiments, the elastic band 13 is not applied until the first use. The flat shape of the masks 1 without any applied elastic 13 allows damage-free stacking, suitable for mass distribution.

For the correct cutting of the filling or the replaceable filter material, a cut-out pattern on paper or cardboard can be provided.

In some embodiments, the filter material is folded double before cutting.

Once correctly cut out, a stiffer piece of material, for example cardboard, with a substantially corresponding shape can be used to be temporarily introduced into the pockets 11 and 12 together with the filter material.

The filter material can be introduced into the tight-fitting pockets 11 and 12, and in some embodiments, the filter material has been cut out in a double-folded state, as mentioned, so that one flap fits into a tight-fitting pocket 11, 12 and the other flap, on the side which would otherwise make contact with the face, can be folded to limit direct contact of the internal layers 3 and 4 with the cheeks in particular.

It is clear that optimisation when cutting out the filter material can lead to increased user comfort.

The filter material 11′ and 12′ can be industrially prefabricated, and for simplified use, adapted to the shape and dimensions of the pockets 11 and 12 and of the internal layers 3 and 4, and possibly taking into account the expected anatomy of the user's face, in order to limit contact of the internal layers 3 and 4 with the cheeks and possibly with the nose.

Optionally, variants can be provided and/or tear-off lines can be provided in the filter material to allow the user to flexibly make adjustments to the shape according to the anatomy of the face and the preferences of the actual user.

The present disclosure also relates to the method of applying and/or wearing a mouth mask, wherein the method comprises at least the step of providing filter material between the skin of the face and a mouth mask, on the one hand, and between at least two layers made of plastic, on the other hand.

In this case, the filter material is divided into two parts in particular, one for each tight-fitting pocket 11, 12 into which filter material 11′ and 12′ can be inserted.

It is clear that the filter material for the two tight-fitting pockets 11 and 12 may consists of one appropriately cut part, wherein, if it comprises two parts, the parts may overlap when in use.

The present disclosure also relates to the filter material with specific design and use.

There is always mention of four layers 2 to 5, but it is clear that additional layers can be provided.

In some embodiments, the layers 2 to 5 must not necessarily all have the same shape and size, and the internal layers 3 and 4 may, for example, have significantly more or larger passages or even have a mesh-like structure.

The present disclosure is not limited to the mouth mask 1 according to the present disclosure, described by way of example and illustrated by the figures; on the contrary, such a mouth mask 1 may be realized in other ways while still remaining within the scope of the present disclosure.

1. A mouth mask configured to be fitted with replacement filters, the mouth mask comprising:
four pieces of plastic foil or layers placed against each other, the four pieces of plastic foil or layers includes a first external layer, a first internal layer, a second internal layer and a second external layer, the four pieces of plastic foil or layers have at least partially corresponding peripheral edges, and the four pieces of plastic foil or layers are connected to each other along a first fraction of their corresponding peripheral edges by a quadruple welded joint connecting the four pieces of plastic foil or layers,
wherein the first external layer and the first internal layer, are joined along a second fraction of their corresponding peripheral edges by a first double welded joint, and the second internal layer and the second external layer are joined along the second fraction of their corresponding peripheral edges by a second double weld joint,
wherein the first internal layer and the second internal layer are not connected along the second fraction of their corresponding peripheral edges, and
wherein no weld is provided along a third fraction of the peripheral edge and the four pieces of plastic foil or layers are unbound there.

2. The mouth mask according to claim 1, wherein the four pieces of plastic foil or layers exhibit a convex shape at the first fraction of their respective peripheral edges, where the quadruple welded joint connects the four pieces of plastic foil or layers to each other.

3. The mouth mask according to claim 1, wherein the peripheral edges have a bent shape at the first fraction.

4. The mouth mask according to claim 1, wherein the welded joints and the layered construction provide two pockets into which a filter material is configured to be inserted.

5. A method of applying and/or wearing a mouth mask, the method comprises at least the step of providing a filter material between a skin of a face of a user and the mouth mask, and between at least two layers of the mouth mask.

6. A filter for a mouth mask, the mouth mask comprising: four pieces of plastic foil or layers placed against each other, the four pieces of plastic foil or layers includes a first external layer, a first internal layer, a second internal layer and a second external layer, the four pieces of plastic foil or layers have at least partially corresponding peripheral edges, and the four pieces of plastic foil or layers are connected to each other along a first fraction of their corresponding peripheral edges by a quadruple welded joint connecting the four pieces of plastic foil or layers, the first external layer and the first internal layer are joined along a second fraction of their corresponding peripheral edges by a first double welded joint, and the second internal layer and the second external layer are joined along the second fraction of their corresponding peripheral edges by a second double weld joint, the first internal layer and the second internal layer are not connected along the second fraction of their corresponding peripheral edges, and no weld is provided along a third fraction of the peripheral edge and the four pieces of plastic foil or layers are unbound there, and the welded joints and the layered construction provide two pockets into which a filter material is configured to be inserted,
wherein the filter has a punched shape made of the filter material, wherein a shape and a dimension of the filter corresponds to a shape and a dimension of the two pockets and of the first internal layer and the second internal layer in order to limit contact of the first internal layer and the second internal layer with cheeks of a user or the cheeks and a nose of a user.

7. The filter according to claim 6, wherein the filter is divided into two parts.

8. The filter according to claim 6, wherein the filter is made of one part, but with two separate flaps, the flaps configured to inserted in the two pockets, a continuous part configured to be placed between a skin of the user and the first internal layer and the second internal layer.

9. A mouth mask set comprising:
the mouth mask according to claim 1; and
a filter having a punched shape made of the filter material,
wherein a shape and a dimension of the filter corresponds to a shape and a dimension of the two pockets and of the first internal layer and the second internal layer in order to limit contact of the first internal layer and the second internal layer with cheeks of a user or the cheeks and a nose of a user.

10. The mouth mask set according to claim 9, wherein the four pieces of plastic foil or layers exhibit a convex shape at the first fraction of their respective peripheral edges, where the quadruple welded joint connects the four pieces of plastic foil or layers to each other.

11. The mouth mask set according to claim 9, wherein the peripheral edges have a bent shape at the first fraction.

12. The mouth mask set according to claim 9, wherein the welded joints and the layered construction provide two pockets into which a filter material is configured to be inserted.

13. The mouth mask set according to claim 9, wherein the filter is divided into two parts.

14. The mouth mask set according to claim 9, wherein the filter is made of one part, but with two separate flaps, the flaps configured to inserted in the two pockets, a continuous part configured to be placed between a skin of the user and the first internal layer and the second internal layer.

15. A method for preparing a mouth mask set according to claim 9, the method comprises the following steps:
together with the filter material, temporarily introducing a stiffer piece of material into the two pockets, such that one flap fits into a tight-fitting pocket and fold the other flap on the side which would otherwise make contact with a face of the user, to limit direct contact of the first internal layer and the second internal layer with the cheeks of the user.

16. The method according to claim 15 further comprising double folding the filter material before cutting the filter material.

17. The mouth mask according to claim 2, wherein the peripheral edges have a bent shape at the first fraction.

18. The mouth mask according to claim 2, wherein the welded joints and the layered construction provide two pockets into which a filter material is configured to be inserted.

19. The mouth mask according to claim 3, wherein the welded joints and the layered construction provide two pockets into which a filter material is configured to be inserted.

20. The mouth mask according to claim 17, wherein the welded joints and the layered construction provide two pockets into which a filter material is configured to be inserted.
